(19) United States
(12) Patent Application Publication
(10) Pub. No.: US 2009/0276803 A1
(43) Pub. Date: Nov. 5, 2009

(54) SCALABLE PEER-TO-PEER STREAMING INTERNET BROADCAST CONTENT

(76) Inventor: Todd A. Weaver, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/433,713

(22) Filed: Apr. 30, 2009

Related U.S. Application Data
(60) Provisional application No. 61/049,333, filed on Apr. 30, 2008.

(51) Int. Cl. H04N 7/10; G06F 15/16; H04N 7/173

(52) U.S. Cl. 725/32; 725/116; 709/231; 709/204

(57) ABSTRACT

Methods, systems, and techniques for providing near real-time streaming of broadcast content, such as television, using peer-to-peer techniques are provided. Example embodiments provide a P2P Streaming Internet Television System (“PSITS”), which enables television content to be encoded, encrypted, and distributed to one or more Internet-ready player computing devices (players) using peer-to-peer computing technology in a closed secure environment. In one embodiment, the PSITS comprises one or more encoders, one or more trackers, one or more seeders, and one or more players, which communicate using a secure protocol in a closed system, which insures the integrity of encoded encrypted signal data to point of presentation on the players. This abstract is provided to comply with rules requiring an abstract, and it is submitted with the intention that it will not be used to interpret or limit the scope or meaning of the claims.

### TECHNICAL FIELD

The present disclosure relates to methods, techniques, and systems for live streaming of broadcast audio and/or visual content over a network and, in particular, to methods, techniques, and systems for delivering streamed broadcast content, such as television, in near real-time using peer-to-peer technology.

### BACKGROUND

Internet television is a large commercial market that remains virtually untapped. Although televised content has been distributed over the Internet, two problems have kept this market from emerging: insufficient bandwidth and lack of intellectual property protection for broadcasted content. Insufficient bandwidth can cause viewing of content that is slow, potentially full of spurts and delays, and fails to give a viewer a “live” viewing experience. Lack of secure intellectual property protection discourages content providers, such as broadcast television networks and online media companies, from making their content widely available, because they have legitimate concerns that their unsecured content may be further copied or distributed in an unauthorized fashion.

There is currently no commercially practicable, scalable, and efficient method for delivering a broadcast signal to a worldwide consumer base. One approach, for example, that some online-media companies haven taken is to simply force Internet Service Providers (“ISPs”) to upgrade their respective infrastructures to provide more bandwidth, hoping to solve the insufficient bandwidth problem. However, the backbone providers are not interested in investing more money into infrastructure for the sole benefit of the large online-media companies without compensation for the substantial increase in their fixed costs. Thus, content providers are caught in a struggle over who will pay for the increased bandwidth.

Another potential approach to the problem of insufficient bandwidth is Multicast streaming, which involves streaming a single signal to multiple destinations. Online-media companies have invested millions of dollars and hours on the Multicast “many-to-many” platform. However, Multicast is doomed to failure because Multicast not only requires cooperation between online-media and backbone providers, it also requires consent by ISPs and complicated hardware and router configuration by end users. Thus, one reason the Internet television industry has yet to emerge is due to problems with the supply of efficient streamed Internet delivered content.

The lack of intellectual property protection also discourages content providers from distributing their content even if sufficient bandwidth were available. Online-media companies are spending millions of dollars attempting to develop Digital Rights Management (DRM) in an effort to protect the intellectual property of content providers. But, to date, not one DRM solution has commercially succeeded for streamed, broadcast content, because the DRM encryption has been cracked, broken, or flawed. Equally problematic is the fact that complicated DRM procedures make it difficult for users to access content that is protected.

For example, media companies have invested millions of dollars and hours in the DRM arena. They have forced hardware manufacturers to embed decoding chips, cabling companies to send digital-only audio and video over their new standards, and set-top-box and television manufacturers to move to digital-only inputs from the DRM laden components. Software has also been similarly burdened with Microsoft Windows Media DRM and Apple's Fairplay. These software DRM attempts operate by locking out users from playing back files unless the user is playing the file back on the original purchased hardware on which the files were initially stored, ending in consumer frustration, and the downfall of DRM in this form.

### BRIEF DESCRIPTION OF THE DRAWINGS

FIG. 1 is a block diagram of an example environment for providing P2P streaming Internet television.

FIG. 2 is an example block diagram of an overview of the example components of a P2P Streaming Internet Television System (“PSITS”) and example interactions between them as used to provide near real-time streamed Internet television.

FIG. 3 is an example block diagram of buffering channel content for propagation to one or more player computing systems in a PSITS.

FIG. 4 is an example block diagram of an example computing system for practicing embodiments of a tracker computing system for tracking information and controlling content distribution in a PSITS.

FIG. 5 is an example block diagram of an example computing system for practicing embodiments of a Seeder computing system for propagating content in a PSITS to one or more players.

FIG. 6 is an example block diagram of an example computing system for practicing embodiments of a Player computing system for receiving, displaying, and propagating live streamed broadcast content according to embodiments of a PSITS.

FIG. 7 is an example block diagram of time-based or frame-based induced interactivity, content insertion, and/or content overlays in an example content stream.

FIGS. 8A-8G are example screen displays of an example Web-based Broadcasting Application available in a PSITS.

FIG. 9 is an example flow diagram of the overall process for broadcasting an example channel using P2P streaming Internet television.

### DETAILED DESCRIPTION

Embodiments described herein provide enhanced computer- and network-based methods, systems, and techniques for the live streaming of broadcast content such as television. Example embodiments provide a P2P Streaming Internet Television System (“PSITS”), which enables television content to be encoded, encrypted, and distributed to one or more Internet-ready player computing devices (players) using peer-to-peer computing technology in a closed (e.g., secure) environment. With the use of peer-to-peer (“P2P”) technology, the PSITS is able to deliver streamed audio and/or visual broadcast content, such as television content, over a wide area network, such as the Internet, by efficient propagation of the content among PSITS player computing systems. The PSITS provides content to a player computing system using the secure content already being provided to one or more other peer computing systems. The use of P2P technology for content propagation avoids increasing the infrastructure bandwidth to display streamed content in near real-time to each player computing system. Accordingly, system bandwidth is spread among the PSITS player computing systems, alleviating overload by efficient distribution.

In addition, the closed nature of the system protects the content from unauthorized copying or sharing because the distribution of the encrypted content and its receipt for display is controlled by the PSITS and because the content is decrypted “just in time,” block by block, for display, and is not stored to memory except for purposes of rewind to replay previously viewed content. Accordingly, the techniques of the PSITS offers a more robust and secure flow of streamed broadcast content to users over a network.

The PSITS also offers tracking capabilities to content providers to allow them, for example, to determine how frequently their content is being viewed, the results of add-on voting, the outcome of commercial opportunities, the effectiveness of advertisement campaigns, etc.

The PSITS is a interdependent system that includes both hardware, in the form of the encoders, various servers, and various software applications designed to achieve a complete signal propagation and delivery system. For live signals, the PSITS encodes and encrypts a television signal at its source, propagates the signal through the PSITS media network, delivers the signal to one or more network-ready devices, which then decrypt the signal for viewing on multiple and potentially varied operating systems or displays.

Although the term “television” content is used in examples throughout, it is to be understood that the methods, systems, and techniques described herein can be applied to any type of audio and/or visual content that is streamed over a network such as the Internet or other networks.

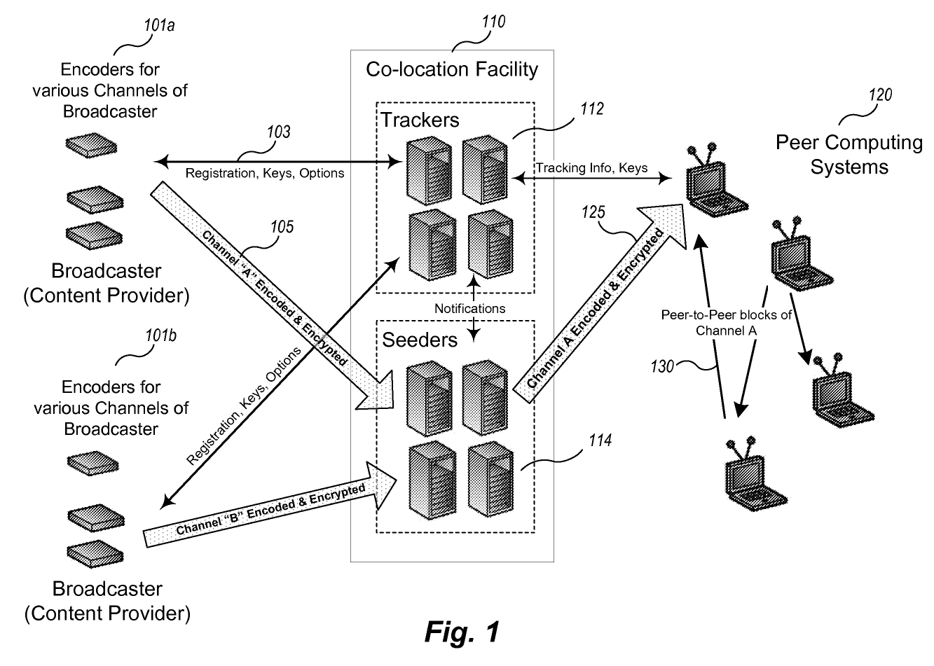

FIG. 1 is a block diagram of an example environment for providing P2P streaming Internet television. In FIG. 1, one or more content providers, such as broadcasters 101a and 101b, provide encoded and encrypted content, for example the signal 105 for Channel A, to one or more seeder computing systems 114 (seeders or seeder servers). In typical configuration, the broadcast location (e.g., a head-end) includes one or more encoders for encoding one or more signals, which each correspond to at least one broadcast channel (when referring to television signals). The signals are encoded by an encoder based upon information received from tracker computing systems 112 (trackers or tracker servers) such as encoding and encryption parameters 103. For example, more than one encoder may be used by a broadcaster to encode the signal of a single channel into different streams, such as flash and high definition encoded signals. Typically, the encoders are provided by audio/visual capture cards or hardware encoding boxes, but in some embodiments they may be provided by a mix of hardware and software, or by software alone. The signals sent by the encoders to the seeders are encrypted as well as encoded based upon information provided by the trackers. In some embodiments, the trackers and seeders are located in a co-location facility 110 for easy access by network-ready (e.g., Internet-ready) player devices 120 (players). In other embodiments the trackers and seeders communicate via standard or proprietary WAN-based network communications mechanisms.

Once an encoded encrypted signal is sent to one or more of the seeders 114, it can be propagated to one or more players 120, which are also peer computing systems (also known as “peers”). In one embodiment, one of the seeders 114, which has been designated by a tracker 112 based upon tracking information, is used to distribute an initial buffer of the encoded encrypted signal 125 to a player 120. At that point, one of the other players 120 is designated by the tracker 112 to provide further buffers of the same streaming signal content, e.g., Channel A signal 125. The trackers 112 control which seeder 114 is used to supply the initial buffer of content, and which one or more peers 120 are used to provide subsequent content, e.g., Channel A blocks 130. Once one or more encrypted and encoded blocks of streamed content are received by a player 120, they are decoded and decrypted using a binary specifically configured and downloaded to the player 120, for display on an output device of the player 120. The signal is buffered on the player 120 in an encrypted form, and is not stored in decrypted form. When the user of the player 120 specifies a desire to rewind to previous content already displayed, the content is read encrypted from memory or other storage devices, decrypted and played back. The other peers 120 are similarly communicating with one or more trackers 112 and seeders 114 to obtain their initial and subsequent content buffers. Using the environment described above, the PSITS can require a user to view all content streamed to a player before allowing rewinding and subsequently fast forwarding, thereby prohibiting a user from skipping over certain content such as advertisements. In addition, all interaction between the components of the PSITS occurs via secured communications (such as SSL protocol) so that keys and other parameters cannot be sniffed by software or hardware external to the player PSITS binary.

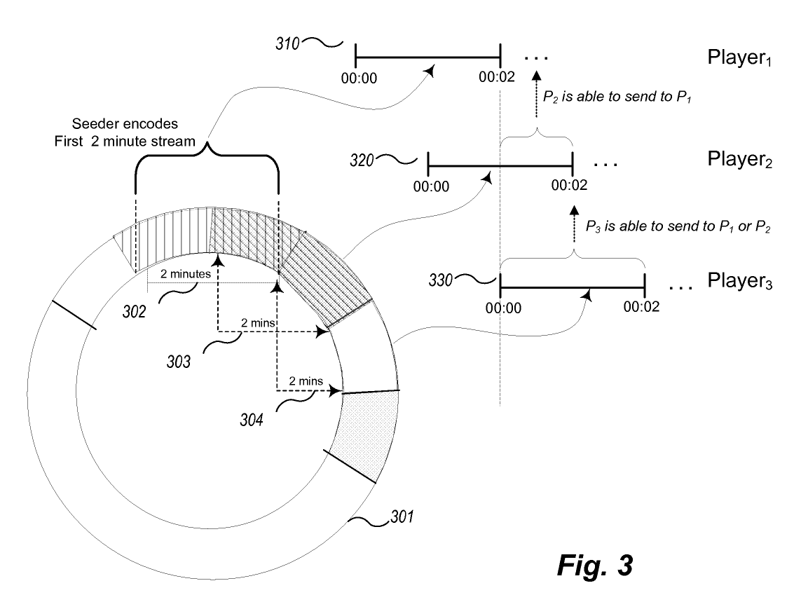

In one example embodiment, content is provided to a player 120 initially in approximately a 2 minute chunk (100 seconds), thus the near real-time nature of the stream is behind the actual live stream by approximately 2 minutes. The initial approximately 2 minutes of content are provided by a seeder 114, and each remaining block is provided by one or more of the peers 120 or by a seeder 114, for example, if no peer is fast enough. The trackers 112 control which blocks of a signal received by a seeder 114 are provided to which peers. This distribution control is described further below with respect to FIG. 3.

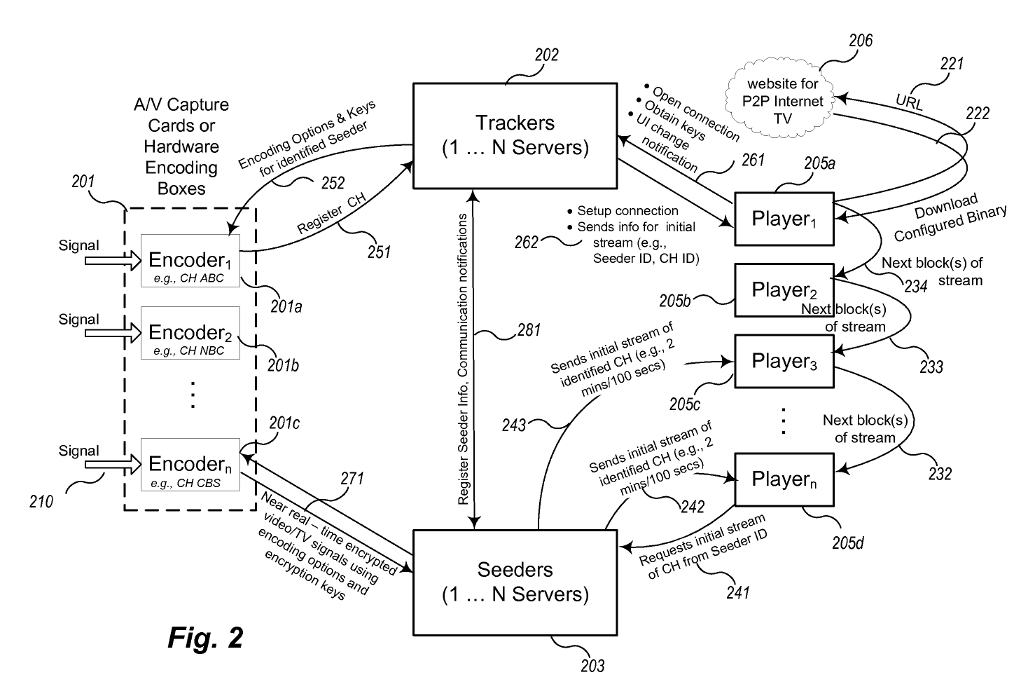

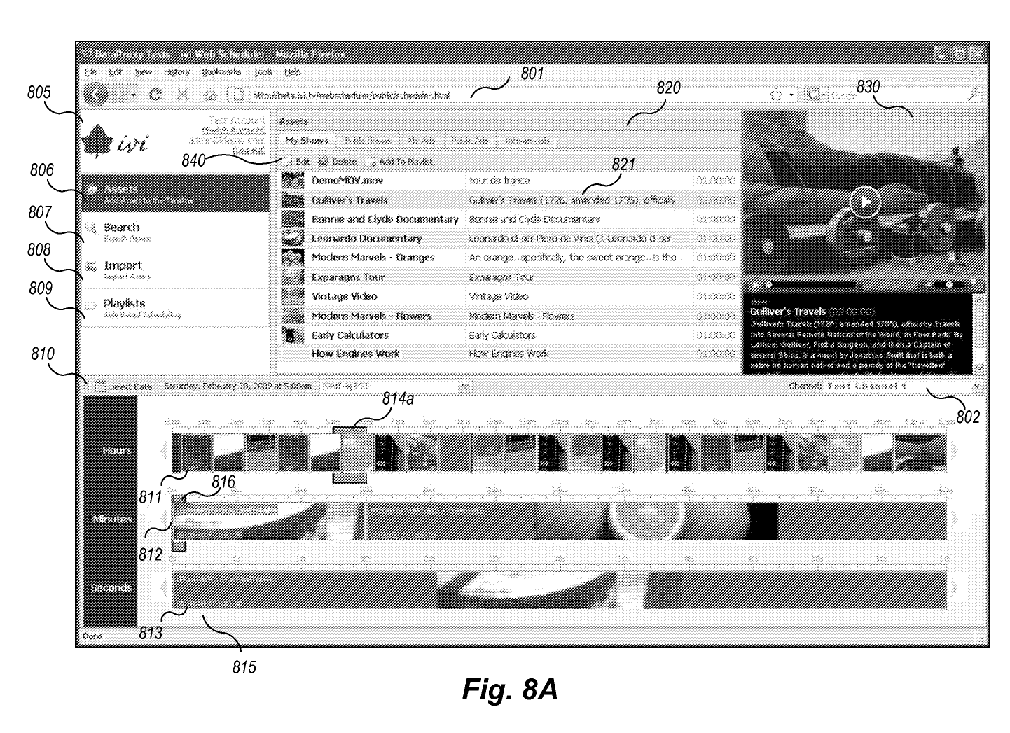

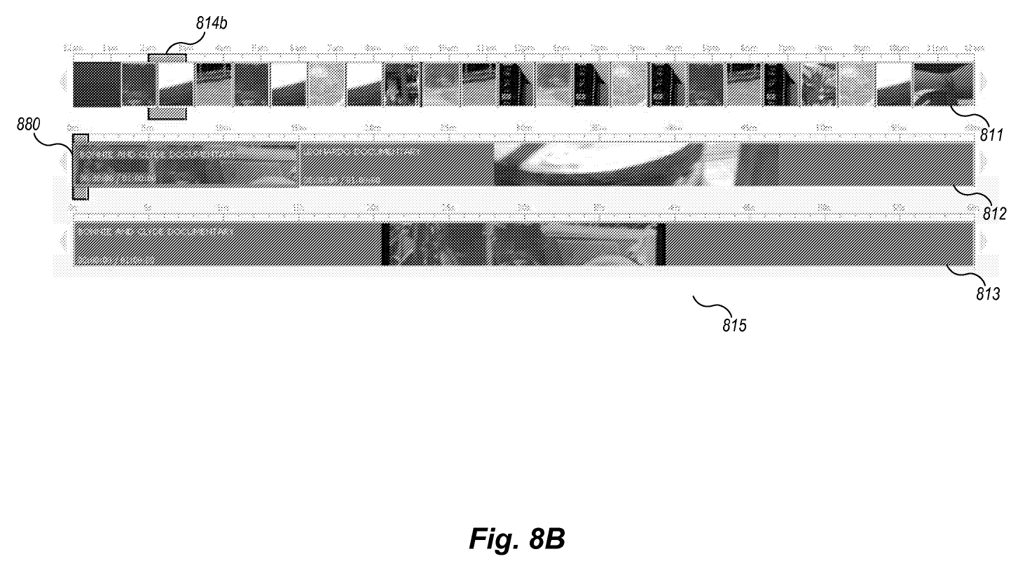

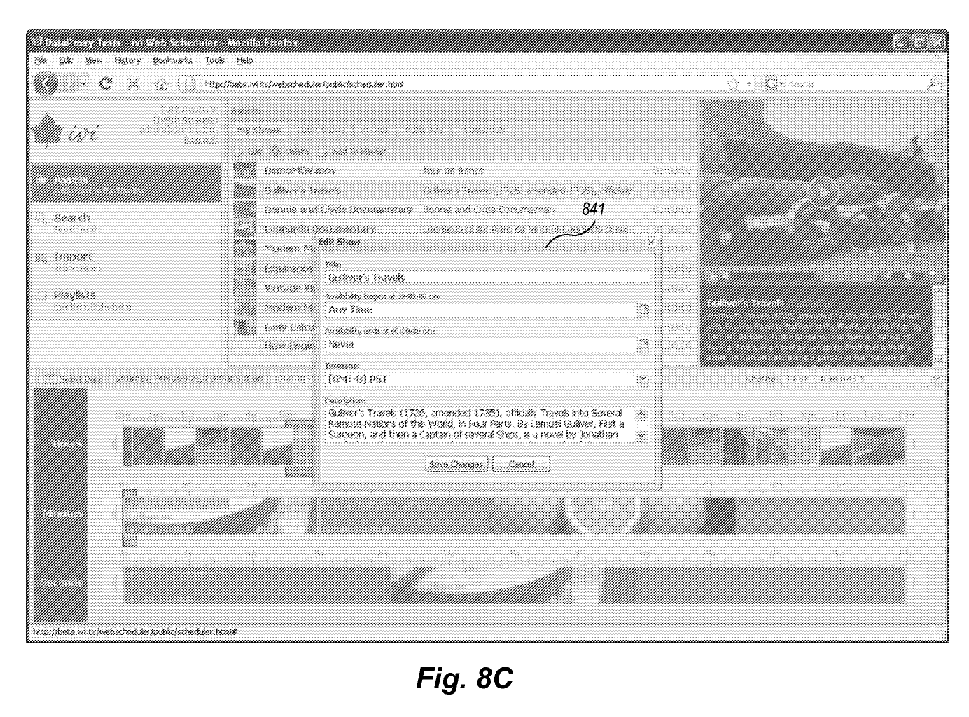

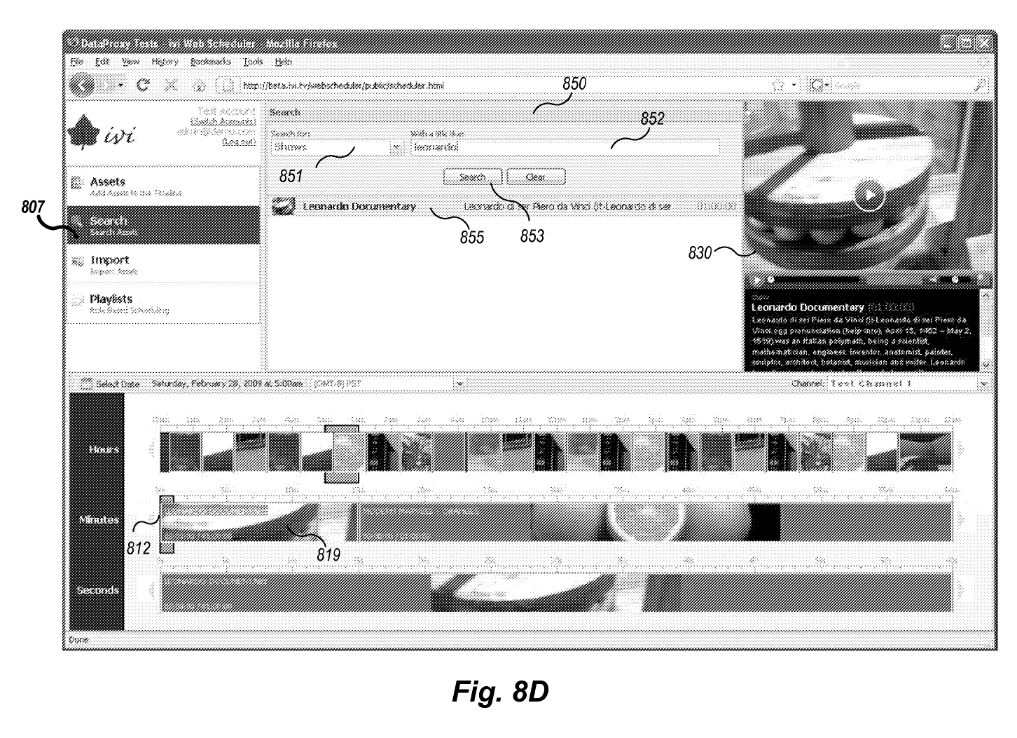

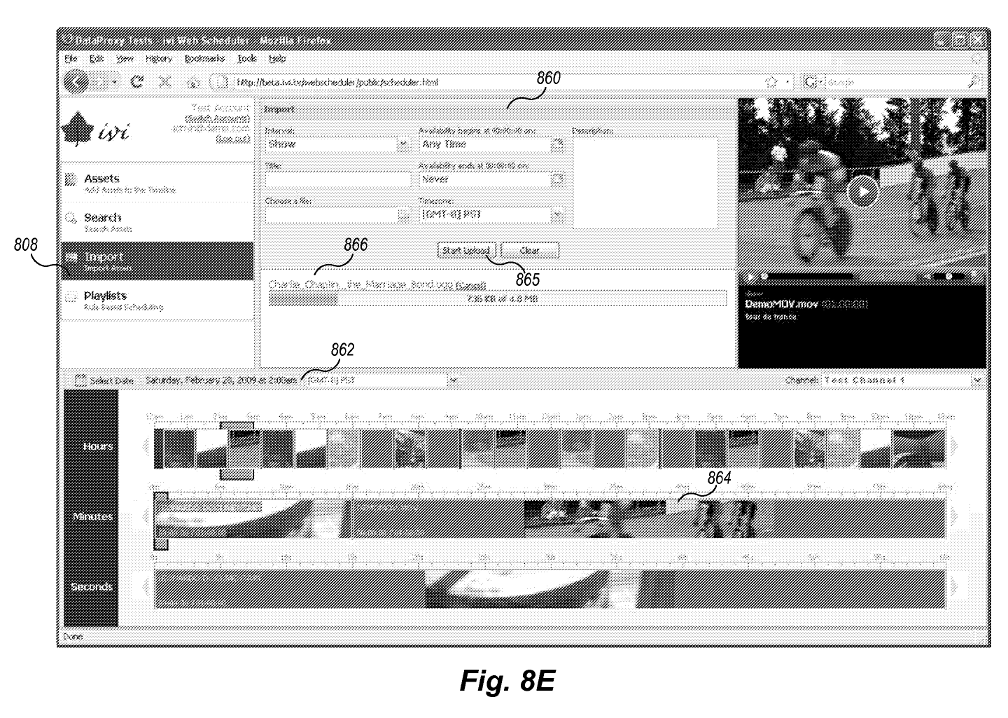

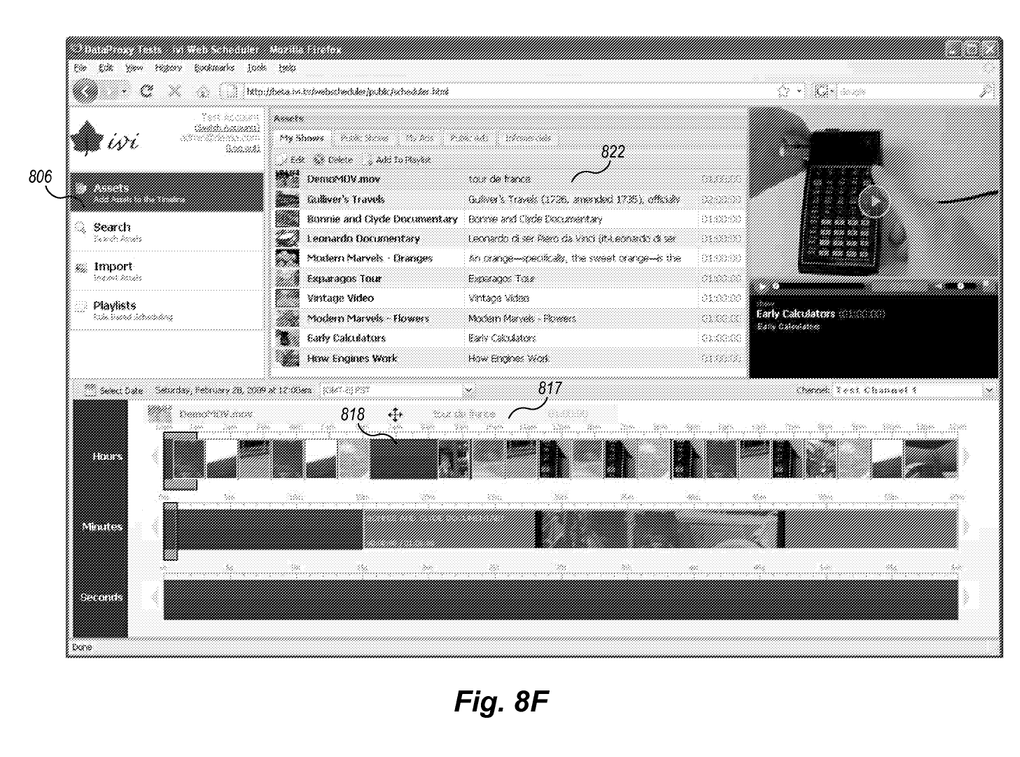

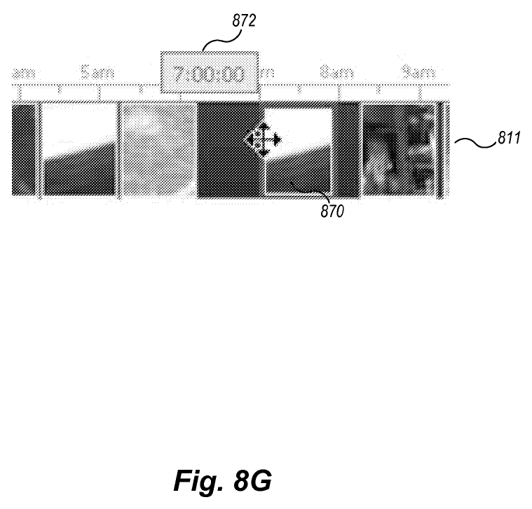

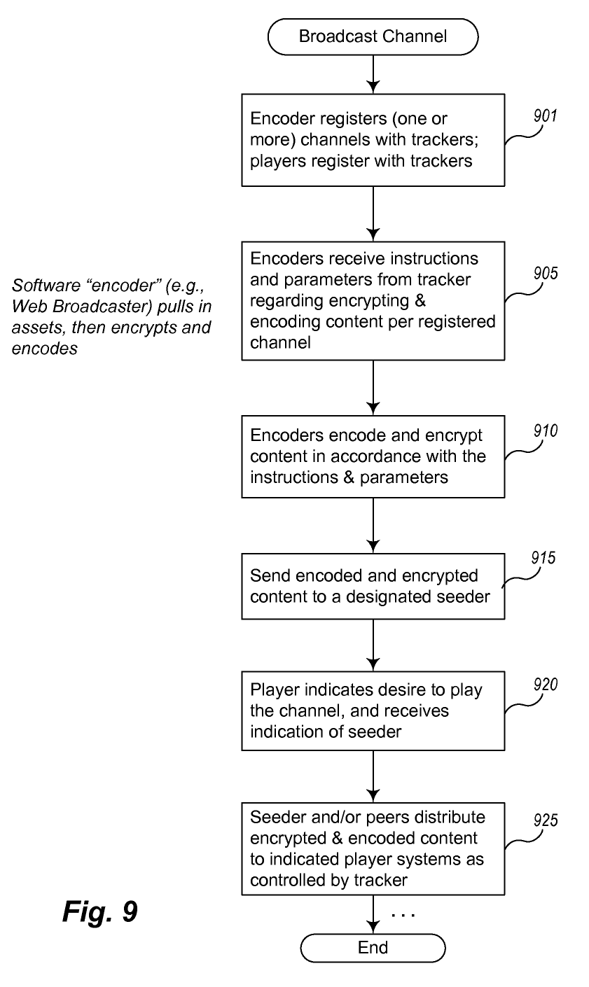

FIG. 9 is an example flow diagram of the overall process for broadcasting an example channel using P2P streaming Internet television. This process is used with the hardware encoders described with respect to FIGS. 1 and 2, as well as the software “encoders” provided, in effect, by the Web Broadcasting Application described with reference to FIGS. 8A-8G. Details of these various steps/blocks are described below with reference to the other figures. In block 901, the encoder register a channel with a tracker, as determined by some initial registration parameters established with the encoder initially registered with the tracker. In block 905, the encoder receives instructions and parameters from the tracker regarding how it needs to encrypt and encode content consistent with the prior registration. In the case of software encoders, the content (assets) for the live stream are uploaded as indicated, for example, by a scheduling timeline. In block 910, the encoders encode and encrypt the content as was indicated by the tracker. In block 915, the encoders send (e.g., stream) the content to a seeder designated by the tracker. In block 920, a player indicates to the tracker interest in playing the channel, and the tracker sends to the player a designated seeder (and/or peer if the channel is already being viewed). In block 925, the designated seeder (or peer) supplies the encrypted, encoded content to the player, and the player subsequently decrypts and decodes the content to display it on an associated display. Other steps/blocks are added as appropriate.

In one example embodiment, the PSITS comprises one or more functional components/modules that work together to provide near real-time streaming Internet television. For example, an example PSITS may comprise one or more trackers, one or more encoders for each broadcast signal, one or more seeders, and one or more players as briefly described above. These components may be implemented in software or hardware or a combination of both.

FIG. 2 is an example block diagram of an overview of the example components of a P2P Streaming Internet Television System (“PSITS”) and example interactions between them as used to provide near real-time streamed Internet television. In particular, at each broadcaster (head-end) one or more encoders 201a, 201b, and 201c (e.g., in the form of A/V capture cards or other hardware encoding boxes 201) are provided to receive one or more television signals 210 from a broadcasting device. Each television signal (e.g., signal 210) approximately corresponds to a channel, for example “Channel NBC” or “Channel ABC.” When an encoder, such as encoder 201a, is activated, it registers itself with a tracker by registering its channel with one of the trackers 202 (event 251). In response, one of the trackers 202 informs the encoder what encoding options should be used, an encryption key, and identifies a particular one or more seeders 203 that the encoded signal is to be sent to (event 252). Encoding options included parameters such as bit rate, frame rate, resolution, streaming capacity, cipher, key rotation time, etc. These encoding options and the encryption key may be updated as frequently as desired, for example, often as a block basis, but more typically every half-hour. After activation, an encoder, e.g. encoder 201c, encodes and encrypts its corresponding live television signal according to the received encoding options and encryption key, and sends the encoded, encrypted signal to the designated seeder 203 (event 271).

Typically, each encoder 201 is a hardware capture device that does software encoding and encrypting. In one embodiment, the hardware device is a standard personal computer (PC) motherboard with an audio and video capture card added. The device requires a fast enough CPU to handle software encoding and encrypting. In an example case, the hardware may include a dual core 3 gigahertz CPU. The capture card receives input as raw PCM audio and raw YUV video, as well as a combination MPEG audio/video stream.

In one embodiment, the encoding software application receives a signal containing both the raw audio and raw video and may multiplex the stream into two different formats: for example, it may multiplex the stream into a single container format and another format or it may receive and process a raw MPEG stream. The encoding software is able to encode received raw audio and video into a highly compressed format by, for example, using the THEORA video codec and the VORBIS audio codec and placing the resulting compressed audio and video into an OGG container. In other embodiments, the encoding software application may multiplex the stream into two formats, for example, one into an OGG container format, and another into a flash based player format such as using the flash H.264 codec. In yet other embodiments, the encoding software application may multiplex the stream into two different flash formats, e.g., VP6 flash and H.264 and not provide a container formation. Other multiplexing arrangements are also possible.

The encrypting software application receives the encoded blocks of the overall stream block by block, and encrypts each block, determines a new block size after encryption, and writes a header line that contains various pertinent block values, such as block size, ID of the key used to encrypt the block, frame number, date and time. The header may be a unique header ID-(number of bytes in the block)-(key ID)-(frame count)-(date/time) format and the body may contain the actual encrypted block. Other formats are of course possible. The encrypting software then reads in the next block and repeats this process on each block in the incoming stream. The overall encoded and encrypted stream is delivered block by block (event 271) via a secure protocol, such as using TCP/IP over SSL, to the designated seeders 203.

Each player in a PSITS, for example players 205a, 205b, 205c, and 205d may be any network-ready device or other component capable of downloading and running a version of the configured PSITS binary. For example, the network-ready device may be a personal computing system with an Internet connection. The PSITS binary is used to communicate with one or more trackers 202, to receive encoded and encrypted blocks from one of the seeders 203 or from a peer player device, to decrypt and present streamed television content on an output device, and potentially to propagate received content to another peer player device. Each player is designed to receive, propagate, decrypt and display numerous channels, each originating from different broadcasters.

A player, for example player 205a, requests from the network, e.g., a web portal 206, an PSITS player application configured for that device (in event 221), which it receives as a downloadable PSITS binary (the player application) configured specifically for that device (event 222). Each downloadable binary contains a unique identifier (ID) for use in identifying that particular player to a tracker 202. The player application may run on multiple platforms in a standard size window application, but, in some embodiments, will be able to expand to a full screen version. When a player application is activated, it opens a connection with one of the trackers 202 (event 261), and obtains information for connection setup including which seeder to use for receiving its initial stream and for which channel (event 262). The downloaded player user interface (“UI”) will have certain selection functions available to a user, including “volume up,” “volume down,” “mute,” “channel up,” “channel down,” “guide,” and “time-shifting” functions “rewind,” “pause/play,” and “fast forward.”

When a user is ready to watch television, the user indicates, for example by selecting an icon provided by the downloaded player UI, that encrypted and encoded content is to be received from the seeder 203 that was designated by the tracker 202. For example, player 205d may request an initial television stream from a designated seeder 203 (event 241). The seeder 203 automatically provides an initial stream from the last visited channel, which may be a default channel when none is provided or when the last one is unavailable (event 242). When the downloaded player UI indicates that a channel has been changed or other time shifting functions have been used, the activity is reported to the tracker 202 (event 261), so that appropriate tracking and actions can be taken/adjusted, for example changing the indication of the last visited channel associated with that particular downloaded player and indicating to the player possibly a new designated seeder 203 from which to request an initial stream (event 241).

After a player application has received an initial stream for immediate viewing (event 242), the player, may receive additional stream chunks/blocks from either a seeder 203 or from a peer player 205a-205d as controlled by a tracker 202. The peer-to-peer propagation process is handled by a tracker 202 as a result of each player registering its tracking information with a tracker 202. A tracker 202 assigns to a player 205a-205d from where to obtain its channel signal. Thus, at any given time, a player can be switched from a seeder 203 sourced signal to a peer sourced signal (from a peer that is viewing the same channel). In one embodiment, the player cannot choose the location of the source of the signal, the tracker 202 handles all the peer-to-peer logic and assigns a stream to each player 205a-205d.

In the example illustrated in FIG. 2, player 205d is initially assigned to obtain the first 2 minutes of the television stream from a seeder 203 (event 242). The subsequent portions (e.g., blocks) of the stream are sourced from player 205c (event 232), which is receiving the same channel signal. In turn, player 205c, after receiving it initial 2 minutes of the same stream (ahead of player 205d) (event 243), receives its subsequent portions of the stream sourced from player 205b (event 233), which is receiving the same channel signal. Similarly, player 205b is receiving its stream blocks from player 205a (event 234), and so on. Accordingly, a peer player can obtain one block from a seeder 203, a subsequent block from a peer player, a third block from a different peer player, all controlled from the trackers 202 stream distribution process. (Although not shown, each player is connected to one or more trackers 202 and seeders 203 and one or more other peers. Events similar to those described for players 205a and 205d are performed accordingly.) Each time the user (the player application) changes channels, a tracker 202 may re-designate which seeders 203 and which peers 205a-205d are used to source the player's signal. Different arrangements, different buffered amounts, etc. can be used to accomplish similar functionality.

Peer players behind NAT or other firewalls pose some complications because their addresses are not available to the trackers 202. In one embodiment, peers are negotiated through a TCP traversal process of sending an outbound request from the receiving player to a tracker 202. The tracker 202 then puts the outbound request in contact with an outbound request from another peer player to establish NAT traversal for peer communication.

Once the encrypted blocks are received by a player, they must be decrypted and decoded in order to present them on a player device. The first process that occurs on incoming blocks is decryption. The decryption process reads the incoming blocks either from a secure TCP pipe or from a local disk. The decryption is performed in memory, block by block. The decrypted blocks are then passed to a decoding engine for the decoding of the video and audio codecs, which handle the display of the video and playing of the synchronized audio to the player's display device and/or sound system.

The decryption process used by a player application can utilize any encryption/decryption method used by the encoders. In one embodiment, each player application includes a decryption module that decrypts each block of all incoming encrypted streams by retrieving an ID of the key used to encrypt the block (e.g., from the block's header) and requesting the key from a tracker 202 using the key ID (event 261). Since the entire communication between the players 205a-205d and the trackers 202 is secure, forwarding the key from the tracker 202 is a safe operation. Since the keys used to encrypt the blocks are changed frequently, the updated keys are made available to the players. In one embodiment, the PSITS uses Public-Key Infrastructure (PKI) encryption, with the trackers 202 being employed to distribute the private keys to the players as needed. In an alternative embodiment, a list of possible encryption keys is downloaded to (e.g., cached on) each player (and simultaneously provided to encoders) and the key ID present in the block header is used to index a key from this list of keys. Other embodiments are possible.

Any encrypting and decrypting cipher can be used, provided the cipher meets certain minimum speed requirements. To protect against cracking and to ensure long-term security retention, the decryption keys are typically rotated regularly. The overall structure of each encrypted block contains a header which has the key identifier, the cipher used, and the size of the encrypted block to decrypt, and also contain a body of encrypted data. In addition, the header may have version information, timestamps, and other information. This structure allows the PSITS to change the decryption key as often as every block, but typically on a regular time basis, for example, every half-hour.

Table 1 below illustrates an example of an encrypted encoded block of content that is usable with the PSITS described. Other arrangements of data, including blocks of data of different sizes and having different, fewer, and/or more fields will also operate with the PSITS described. Table 1 illustrates one example embodiment in which each block contains one section of encoded and encrypted video. The offset and length values are shown in bytes.

TABLE 1

| Offset | Length | Description |
|---|---|---|
| 0 | 20 | Block HMAC |
| 20 | 1 | Version |
| 21 | 1 | Flags |
| 22 | 2 | Data Length |
| 24 | 4 | Stream ID |
| 28 | 4 | Timestamp |
| 32 | 20 | Key ID |
| 52 | 16 | Initialization Vector |
| 68 | (rest) | Encrypted Data |
| | | (payload) |

The block HMAC is the message authentication code used for the block (in one embodiment, an HMAC SHA-1 algorithm is used). Version refers to the version of the block layout used; data length is the size of the payload; timestamp is an indication of time (encoding time) when the block was created. This timestamp may be used for interactivity as well as to provide tracking information. The other fields are used for other purposes. As mentioned above, other arrangements and fields are contemplated for use with the techniques of the PSITS—Table 1 describes one possible layout that shows how encryption information, timestamp, and encoded data may be placed in (for example, 1 second) blocks, for distribution to players.

As mentioned, a user may use the downloaded player UI to replay a segment of the received channel signal. In one embodiment, a user who receives the continuous, streaming signal on the player is allowed a time limited window to pause or rewind the signal. After pausing or rewinding, the user is then able to fast-forward the signal to catch up to the “live-time” signal (signal as produced by the seeder). This is referred to as “time shifting” the signal. The PSITS is designed to accommodate time shifting of archived content as well. In one embodiment, the PSITS is designed to restrict the ability of users to fast forward through archived content, until the content has been viewed in near real-time at least one time. The purpose of this feature is to insure that all embedded advertising is viewed by users at least once. Other embodiments do not include such a restriction.

For example, the downloaded player UI may offer a “television guide,” which may be accessible directly from the player's video screen. Channel guide information may be updated to players periodically from the trackers. Once a channel is selected, for example by using a mouse click or other input signal, the player application connects to the tracker and is directed to a requested channel stream from a designated seeder or to a requested channel stream from a designated peer.

In some embodiments, the television guide is an on-screen display that shows past, current and future programming content on the player, in one embodiment designating a discrete row for every channel in the network. The guide gives users the ability to scroll backwards in time to see what has been played, or forward in time to see what will be playing. By selecting (for example, clicking on) a selected program that has already played, users can download an archived copy of that program. By selecting a current program, users can watch that program live on the player device. By selecting a program that will be played in the future, users can schedule the player to watch that program in the future.

Time shifting can be handled by buffering blocks to disk as the storage medium. The pause, play, rewind, and fast-forward functions inform the player application what action to take on those buffered blocks on disk. Because everything that is kept (even temporarily) on disk is encrypted, the PSITS player is the only application that can read, rewind, fast-forward, play, or pause the blocks buffered on disk. When the player application initially launches or changes to a new channel, it receives a specified burst of that channel (in one embodiment, approximately two-minutes or 100 seconds) from a seeder 203, so that the player contents have a small delay from the broadcaster's live signal (approximately two-minutes, if that is the burst time used). If the user pauses or rewinds, the lag behind the broadcaster's live signal increases. If the user fast-forwards, the lag behind the broadcaster's signal decreases, but can never lag behind the minimum buffer, set in one embodiment at 100 seconds.

Each tracker of the one or more trackers 202 in a PSITS is responsible for controlling the flow of broadcast signals from the encoders, through the seeders, to the peers of the PSITS network. These signals may come from hardware encoders such as those exemplified in FIGS. 1 and 2, or the software broadcasting tool described below with respect to FIGS. 8A-8G. Accordingly, the trackers 202 are the central tracking device(s) for the PSITS media network. In one embodiment, the trackers 202 are a single hardware device or multiple hardware devices (or software equivalents) that share the same tracking data about the encoders, seeders, and players in the PSITS media network. As mentioned, the one or more trackers 202 provide instructions to each encoder directing to which seeder 203 to provide the encoded encrypted broadcast signal and the encoding options and encryption key to use to encode and encrypt the signal. The trackers 202 also receive channel registration when an encoder comes on-line.

The trackers 202 also keep track of all the seeders 203 on the network. When a seeder 203 comes on-line, it registers itself with the trackers 202 and the trackers 203 retain that registration. Also, the trackers 202 communicate with the seeders regarding notification of, for example, encoders that are no longer available (event 281).

The trackers 202 also communicate with each player to track data regarding viewing habits and to control the distribution of the signals to a player from the one or more seeders 203 and from the peer players that are viewing the same signals. When a player application (a “player”) is downloaded from the PSITS website, a unique key is assigned to that player and registered with the trackers 202. When the player is first brought on-line, it registers itself with the trackers 202 and receives information about which channel the specific player was last watching and designates which seeder 203 will give it the initial feed as described above. Every action of the player application is delivered to the trackers 202 including channel changes, volume changes, rewind, pause, mute, and selections from the guide, which allows a fine granularity of tracking to be performed.

The trackers 202 are designed so that the viewing habits of every user on the PSITS network are tracked and cataloged. Broadcasters can be provided detailed demographic information about viewers of their programming. Because each player application has a unique identification number embedded into its binary, the tracker 202 can track data such as number of views, duration of views, repeat views, and the demographic profiles of the specific viewing audience of every broadcast signal. In addition, the timestamps associated with the encoded content as compared with the time viewed can be provided to the broadcasters, allowing them to compute detailed information regarding things like skipped programming, delay in watching, etc. Frame numbers are also available from the encoded content; hence, the recipients of the tracked information may obtain details down to which frame the user was watching, at what real time, in additional to knowing what time that frame was distributed as a broadcast. This tracking also allows broadcasters to potentially obtain information on “referrals”—that is what shows/ads from what broadcasters were responsible, for example, for upgrades in subscriptions. This kind of tracking may support business and payment models that payout to broadcasters based upon specific referrals and not just flat subscription fees.

Each seeder of the one or more seeders 203 in a PSITS is responsible for buffering the encoded encrypted signal received from the encoders 201 and distributing one or more blocks of the received signal to one or more players 205a-205d as determined and controlled by the trackers 202. It is also responsible for registering itself with the trackers 202 and for communicating with the trackers 202 regarding loss of communication with a particular encoder 201.

Abstractly, each seeder 203 can buffer a signal using a circular buffer data structure. (The seeder application code may use other types of data structures and concepts for storing, buffering, or caching the received signal data.) FIG. 3 is an example block diagram of buffering channel content for propagation to one or more player computing systems in a PSITS network. A data structure 301 for implementing a circular buffer is illustrated in FIG. 3. The illustrated buffer 301 holds 2-minute segments (blocks) of encoded and encrypted channel signal data for purposes of illustration, such as segments 302-304, sent by an encoder, such as one of the encoders 201 in FIG. 2. Measurements of segments other than 2-minute segments can be similarly incorporated. (In one embodiment, segments of 100 seconds are used instead of 2-minute segments.) When a player, such as Player₁ has been directed by a tracker to obtain its signal data from the seeder whose data buffer is shown, followed by peer Player₂, the propagation of the first three 2-minute segments 302-304 may proceed as follows. The third segment 304 is initially delivered during time period 330 to Player₃ (Player₃ already has received the first and second segments, 302 and 303); the second segment 303 is initially delivered during time period 320 to Player₂ (Player₂ already has received the first segment, 302); and the first segment 302 is initially delivered during time period 310 to Player₁. Since Player₁ is displaying (and potentially propagating) the first 2-minute segment 302 in the channel block sequence behind in time relative to Player₂ and Player₃, Player₁ can obtain the second 2-minute segment 303 from Player₂ or from Player₃, because these players have received them already. In real time measurements, the presentation of the channel signal on a display of Player₁ is approximately 2 minutes (or 100 seconds) behind the live television signal.

Also, although not shown, a seeder can utilize delivery of the initial signal to test the reception of a player to determine its fit for receiving data from a peer system. In some embodiments, the seeder tests a player each time a signal is delivered (e.g. initial delivery or in response to a channel change) and at vary other times as desired.

The environments illustrated in FIGS. 1 and 2 are oriented to distributing typically already existing live streams as broadcast channel content through encoders to the PSITS. Such environments are more typically found with professional broadcasters such as cable and satellite broadcasters, or independent or low-powered television broadcasters such as some international broadcasters or targeted (niche) or limited television signal generators. Such broadcasters are connected to the PSITS by incorporating encoders that know how to communicate with the trackers and seeders of the PSITS.

In addition to these broadcasters, the PSITS supports an environment for broadcasters who wish to create a “live” stream (channel), for example, from their own personal computing systems. Once such a stream is created, the stream can be distributed through the trackers, seeders, and players, just like the encoders 101a, 101b, and 201, for example, according to process overviewed in FIG. 9. The PSITS implements a software based broadcasting tool for this purpose. This tool can be used to provide archived content, or a combination of archived and real time streamed content using an encoder. For convenience, such broadcasters will be referred to as “desktop broadcasters,” although anyone may use such a tool. For example, an individual may wish to provide streamed archived content of his favorite movies to all of his family members over a single channel. In addition, he may own and deploy a hardware encoder, hooked up to a video camera in order to stream videos of his kids sports games. By using the tool, he can control what content, archived, mixed, or solely camera based, he distributes over his “family” channel. Once the content is specified and arranged on a broadcast timeline, he can make the channel available—just like the other channels distributed over the PSITS—and the content is propagated by the trackers, seeders, and peers to the players as described with reference to FIGS. 1, 2, 3, and 9.

FIGS. 8A-8G are example screen displays of an example Web-based Broadcasting Application available in a PSITS. In FIG. 8A, the broadcasting application (tool) 805 supports the finding, and arranging assets (video and/or video/audio content) on a broadcast timeline. In one embodiment, the tool 805 is executed in a standard client browser by navigating to a web page 801. In other embodiments, it make be executed as another form of client application, such as a standalone application. The broadcasting tool 805 allows for assets to be defined, labeled and added to the timeline using assets page 806; for searching for assets using search page 807; for importing (uploading) assets using import page 808, and for defining playlists using playlist page 809. Playlists allow a user to define a portion of a broadcast timeline, which can be named and repeated as desired to fill a broadcast channel. This capability is useful, for example, when a desktop broadcaster, such as a blogger, is sent a small number of video clips each day, that do not provide a full day's worth of programming.

The broadcast tool 805 provides a broadcast timeline 815 on which content (e.g., video assets) can be placed, using for example, direct manipulation techniques. The timeline 815 includes 3 subsets: an hour timeline 811; a minutes timeline 812 reflecting the 60 minutes within a selected hour (e.g., selected hour 814a); and a seconds timeline 813, reflecting the 60 seconds within the selected minute (e.g., selected minute 816) within the selected hour. This allows the desktop broadcaster a fine degree of precision. The timeline 815 is reflected of the broadcasting content that is (to be) broadcast on the selected channel 802. The broadcaster may choose to test a channel before releasing it live, but the broadcaster can change content to be broadcast in the future. Typically, when an asset is selected on the timeline, for example the asset selected during the selected hour 814a and selected minute 816, it may be displayed in the preview window 830, unless an asset is selected and being manipulated in other parts of the tool 805.

FIG. 8B is a close-up of the broadcast timeline 815. The selected hour 814b is indicated at 2 am to 3 am, which corresponds to two different assets—the Bonnie and Clyde documentary and the Leonardo documentary. Correspondingly, the first documentary 880 is shown as the selected asset to be manipulated on the minute timeline 812. Details of the first documentary 880 are shown on the seconds timeline 813. This granularity allows the broadcaster to carefully move the asset within the allocated time space, perhaps to integrate an advertisement (ad) or other message.

Returning to FIG. 8A, using the Assets page 806 (form/dialog etc.), the desktop broadcaster can display the various assets already archived for potential broadcast, arranged according to a set of libraries 820. The libraries shown include “my shows,” “public shows,” “my ads,” “public ads,” and “infomercials,” although other libraries may be provided. The public shows and ads may used to arrange content received publicly and the my shows and ads may be used to arrange personal content. In the displayed library, the broadcaster has chose asset 821 (“Gulliver's Travels”) to edit using user edit control 840. Note that using the other user interface controls, the broadcaster can delete the selected asset or add it to a playlist. Other controls are supportable similarly. The current asset 821 is previewed in the preview window 830.

Once the broadcaster selects the edit control 840, an edit window is displayed, such as that shown in FIG. 8C. The broadcaster can set up identifying or other classifying information using this dialog 841.

The broadcaster can navigate to the Search page 807 to find a particular asset. FIG. 8D shows an example of a search dialog 850 in the shows library entered into library selection control 851, for an asset whose title is entered into search control 852, here “leonardo.” When the broadcaster selects the “search” button 853, the tool 805 responds with a matching asset 855 (if one is available). In some embodiments, if the matching asset 855 is already arranged (at least once) in the broadcast timeline, then one of the matching assets 819 is highlighted there as well.

The broadcaster can also navigate to the Import page 808 to upload and import an asset. FIG. 8E is an example of an import dialog 860 used to import an indicated asset. In this case (not shown), the user is first prompted to browse or otherwise indicate which asset s/he wishes to upload and import. Then, once the user presses the upload control 865, the tool 805 begins to load in the asset in order to store it as usable content. Progress indicator 866 is used to indicate progress during the upload procedure. Note that, as an example, the preview window currently displays the asset indicated in the previously selected hour and minute—selection 864.

Once assets are labeled and stored in libraries as desired, the broadcaster can move desired assets into the broadcast timeline for distribution on the registered channel. FIG. 8F is an example screen of the Assets page 806 used for this purpose. The user selects an asset 822, and moves the asset, for example, using direct manipulation of an input device associated with the system, down to the timeline area. The asset 817 is shown in the process of being moved to the broadcast timeline into space 818.

FIG. 8G shows a close-up of an asset, such as asset 817, being moved to the timeline. Here the asset 870 is being moved to the hour timeline 811 at 7:00:00 am shown as highlighted time 872. Of note, the asset is smaller than the entire hour, thus there is blank space shown surrounding asset 870. The broadcaster can align broadcast of the asset with the preceding or succeeding asset, or can leave it where it is. In addition, ads, or other such content, may be placed to occupy the blank space shown.

Presuming the channel has been registered for immediate distribution, the tool 805 distributes the (stored) content of the channel to the trackers just as any other encoder. When the tools stores assets, they are stored encoded and encrypted according to the registration parameters previously received from a tracker (see block 910 of FIG. 9). Thus, the tool 805 retrieves the encoded, encrypted content and distributes it to a designated seeder (for example, according to step 915). Accordingly, the broadcasting of content provided by the broadcast tool 805 operates just as other content that is sent to the seeders for distribution. In the case that there is no hardware encoder (such as with an augmented or hybrid system previously described) the content that is broadcast is archived content as opposed to content that may be generated in real time such as a live feed. The broadcasting tool does provide users with an ability to distribute arbitrary video (or A/V) content using the PSITS just like other broadcasters (see FIG. 9).

The embodiments of a PSITS described in FIGS. 1-3, and 8A-8G may be augmented with additional functionality. For example, some embodiments of the PSITS provide a “transactional overlay” to support interactivity on a player. Also, in some embodiments, time code-based and frame-based interactive or inserted events such as inserted advertisements are supported.

More specifically, different types of events can trigger a content overlay or content insertion. In one case, the underlying content stream continues while the added content is played. In another case, the underlying content stream is halted or paused while the added content is played, and then continues where it left off. These events may be triggered by for example, indicators from the broadcasters content stream (e.g., blank ad block(s)), a time code or frame-based event indicated by the tracker, or one indicated by a player. Such different triggering allows for customization of the added content or ads by the broadcaster, tracker, or player and allows for customization nationally, regionally, locally, etc.

The transactional overlay is typically implemented by a transparent software application that allows users to submit information while viewing programming on the PSITS. Examples may include, for example, voting for contestants on reality shows, purchasing items seen on a televised home shopping network, and chatting with other members of the media network who share similar tastes in television programming. The transactional overlay instructs users how to interact, collects that interactive information, and routes the information to a designated tracker and the applicable broadcaster or advertiser.

In one embodiment, the transactional overlay is a transparent input capture layer that allows a broadcaster or the PSITS to grab user input on the player. This process begins when the player receives a block or frame that triggers use of an overlay. For example, as described above, at a particular time code or frame the player may be programmed to play the transactional overlay (for example, as a result of its own event logic or that of the tracker). The user of the player is then prompted to enter into an interactive transaction, for example, a voting transaction, a purchase transaction, a chat request transaction, or any other interactive transaction.

For example, a user watching a show on the player may see a product that the user may be interested in purchasing. The transactional overlay can show the user how to interact with the program to purchase that product. Through the triggered overlay, the user is made aware that the product is available for purchase while watching live, or while watching an archived, or while watching time-shifted content. The user can then click on the overlay to send the requested purchase transaction back to the PSITS and the product distributor. As another example, a user watching a reality show may be prompted by a certain frame or block that displays a voting box that allows the user to vote and have the results sent back to the PSITS and the broadcaster. Some embodiments of the transactional overlays permit the broadcasted content to continue streaming; others may temporarily halt or pause the stream until the transaction is complete.

Some embodiments of the PSITS also support various methods of advertisement (ad) insertion. For example, the encoding process used by the encoders may allow for targeted insertion of video advertisements at certain points in the buffered stream. Further, the PSITS encoding process may designate certain blocks of time (time codes or particular frames) that can be filled with advertisements by a seeder and/or by a player. When filled by a seeder, an advertisement is typically inserted before the buffered signal is disseminated to the players on the media network. When filled by a player, the advertisement may be provided by a tracker. The PSITS can fill those blocks of time with advertisements from a variety of sources, both internal and external to the media system. For example, 3^{rd} party advertising systems may be used to supply an appropriate ad based upon information known by the tracker. This allows the PSITS to fill certain programs with national or international advertisements, and other, local programs, with narrowcasted, targeted advertisements. As described above, the players may be configured to insure that advertisements will be watched by end users (at least once), and that those advertising views can be tracked and compiled by the tracker.

At the encoder level, Broadcasters can encode advertising triggers at certain frames which the PSITS can choose to replace with general advertising that will get distributed to all viewers of the signal, or opt to not replace the advertising trigger frame, letting it pass through to a player, which may replace the frame from the tracker with a narrowcast or targeted advertisement at the time of playback or may replace the frame from local, player based content. The combination of global or general advertisement by a seeder and targeted advertisement insertion by a media player and/or tracker provides a user experience that is equivalent to traditional television broadcasters' method of pushing national and local ads through local affiliates. However, unlike those local affiliates, the PSITS inserted advertisements may be delivered on an individual basis, not just to a local media market. As an example, in a television show with a six-advertisement block, the PSITS could supply three national ads mixed with three targeted, narrowcast ads, all seamlessly viewed by a user.

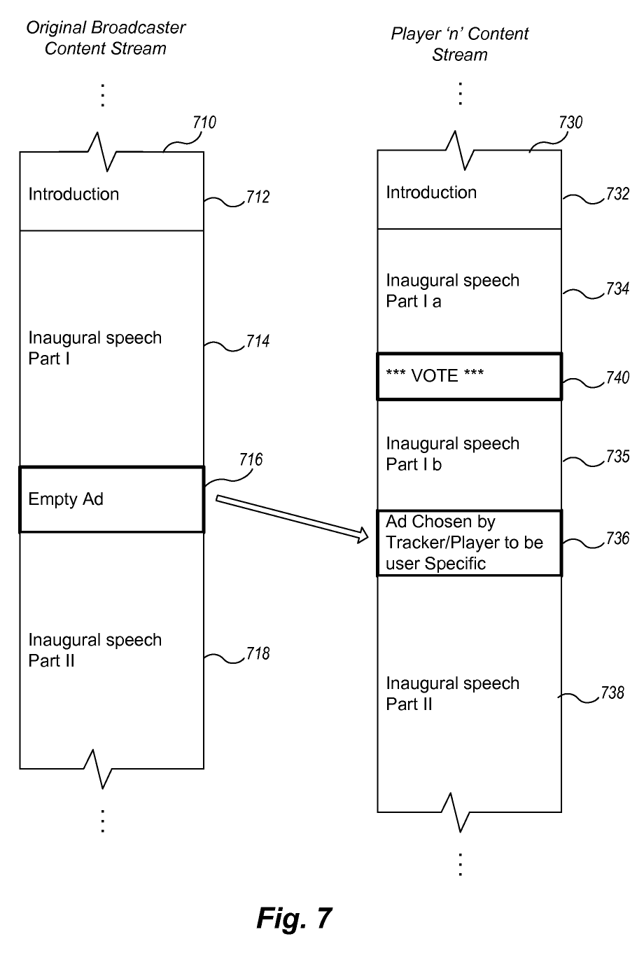

FIG. 7 is an example block diagram of time-based or frame-based induced interactivity, content insertion, and/or content overlays in an example content stream. In content stream 710, the broadcaster has indicated part I of an inaugural speech 714, followed by a series of blocks which are meant to trigger advertisements 716, followed by part II of the inaugural speech 718. When a player plays the content stream 730, the player plays a portion a of the inaugural speech 734, and decides, for example, based upon a time-code or frame-based triggering event, to display an interactive voting blocks 740 to indicate to the tracker (hence broadcaster) whether the user of the player likes or dislikes the contents of the speech so far. In the example shown, the voting frames/blocks may be displayed by a separate transactional overlay system, or may be blocks directly loaded, interspersed, with the content stream as shown. The second part, part b of the inaugural speech part 1735 is played only after the voting is complete. When the player reaches the empty ad blocks 716, the player substitutes one or more ads 736 that are player/tracker/or seeder specific. The inaugural speech part II 738 then continues after the amount of time/blocks indicated by chosen ad(s) 736.

Although the techniques of peer-to-peer signal propagation and the PSITS are generally applicable to any type of broadcast signal, the phrase “television signal,” “channel signal,” etc. is used generally to imply any type of broadcast audio and/or video signal. In addition, the concepts and techniques described are applicable to other arrangements for broadcasting signals and for encoding and encrypting them.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a P2P Streaming Internet Television System to be used for efficient broadcasting and propagation of television channel signals to receiving devices over a network. Other embodiments of the described techniques may be used for other purposes, including for radio, music, talk, and other audio channels, for digital signage video, narrowcasted television, enterprise television, etc. In this description, numerous specific details are set forth, such as data formats and code sequences, etc., in order to provide a thorough understanding of the described techniques. The embodiments described also can be practiced without some of the specific details described herein, or with other specific details, such as changes with respect to the organization of different PSITS functionality, etc.

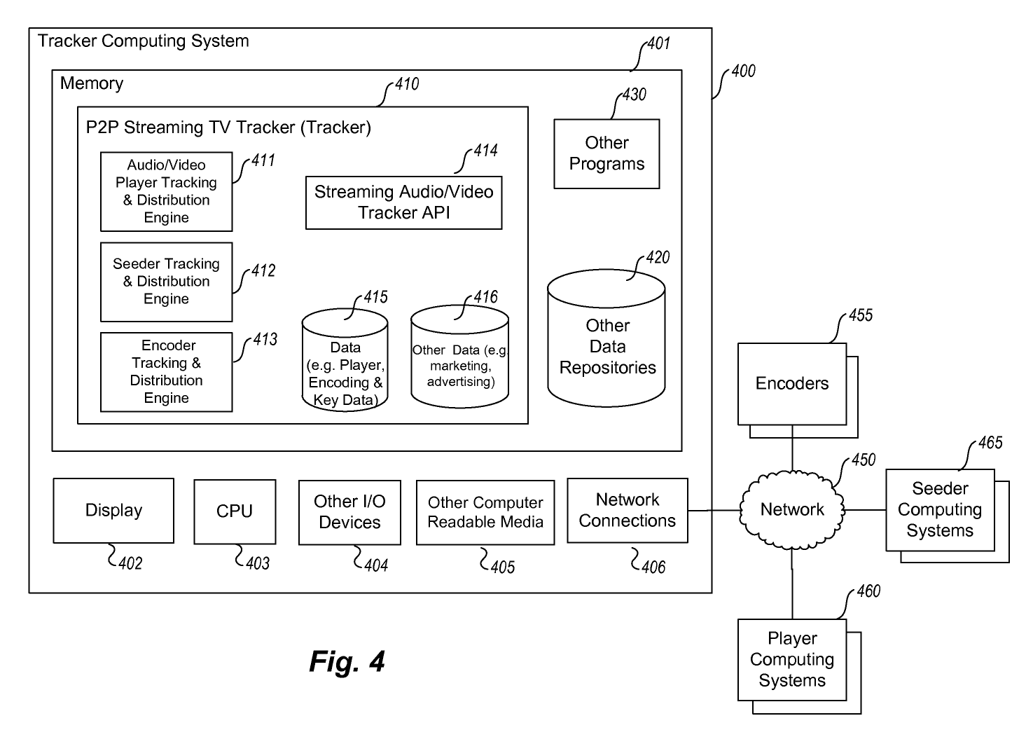

FIG. 4 is an example block diagram of an example computing system for practicing embodiments of a tracker computing system for tracking information and controlling content distribution in a PSITS. Note that a general purpose or a special purpose computing system may be used to implement a tracker of a PSITS. Further, the tracker may be implemented in software, hardware, firmware, or in some combination to achieve the capabilities described herein.

The tracker computing system 400 may comprise one or more server and/or client computing systems and may span distributed locations. In addition, each block shown may represent one or more such blocks as appropriate to a specific embodiment or may be combined with other blocks. Moreover, the various blocks of a P2P streaming TV tracker (tracker) 410 may physically reside on one or more machines, which use standard (e.g., TCP/IP), secure (e.g., SSL) or proprietary interprocess communication mechanisms to communicate with each other.

In the embodiment shown, tracker computer system 400 comprises a computer memory (“memory”) 401, a display 402, one or more Central Processing Units (“CPU”) 403, Input/Output devices 404 (e.g., keyboard, mouse, CRT or LCD display, etc.), other computer-readable media 405, and network connections 406. The tracker 410 is shown residing in memory 401. In other embodiments, some portion of the contents, some of, or all of the components of the tracker 410 may be stored on and/or transmitted over the other computer-readable media 405. The components of the tracker 410 preferably execute on one or more CPUs 403 and manage the tracking of player, encoder, and seeder information and the controlling of content distribution in a PSITS, as described herein. Other code or programs 430 and potentially other data repositories, such as data repository 420, also reside in the memory 410, and preferably execute on one or more CPUs 403. Of note, one or more of the components in FIG. 4 may not be present in any specific implementation. For example, some embodiments embedded in other software or hardware many not provide means for user input or display.

In a typical embodiment, the tracker 410 includes one or more audio/video player tracking and distribution engines 411, one or more seeder tracking and distribution engines 412, one or more encoder tracking and distributions engines 413, a data repository 415 storing data such as player or encoding data, and a data repository 416 for storing other data such as marketing or advertising data. In at least some embodiments, one or more of engines 411-413 or the data repositories 415-416 may be provided external to the tracker 410 and is available, potentially, over one or more networks 450. Other and /or different modules may be implemented. For example, in some embodiments, a streaming audio/video tracker application programming interface (“API”) may be available for accessing data stored in the repositories 415-416 or for accessing the tracking and distribution functions of engines 411-413. In addition, the tracker 410 may interact via a network 450 with encoders or broadcaster systems 450, one or more player computing systems 460, and/or one or more seeder computing systems 465. Also, of note, the data repository 416 may be provided external to the tracker as well, for example in a marketing knowledge base accessible over one or more networks 450.

In an example embodiment, components/modules of the tracker 410 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may use well-known or proprietary synchronous or asynchronous client-sever computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using secure message passing techniques. Equivalent synchronous embodiments are also supported by an tracker implementation.

In addition, programming interfaces to the data stored as part of the tracker 410 (e.g., in the data repositories 416 and 417) can be available by standard means such as through C, C++, C#, and Java APIs; libraries for accessing files, databases, or other data repositories; through scripting languages such as XML; or through Web servers, FTP servers, or other types of servers providing access to stored data. The data repositories 414 and 415 may be implemented as one or more database systems, file systems, or any other method known in the art for storing such information, or any combination of the above, including implementation using distributed computing techniques. In addition, routines for accessing the tracking data may be implemented as stored procedures, or methods attached to player, encoder, or seed “objects,” although other techniques can be also effective.

Also the example tracker 410 may be implemented in a distributed environment comprising multiple, even heterogeneous, computer systems and networks. For example, in one embodiment, the audio/video player tracking and distribution engine 411, the seeder tracking and distribution engine 412, and the encoder tracking and distribution engine 413 may be located in physically different computer systems. In another embodiment, various modules of the tracker 410 are hosted each on a separate server machine and may be remotely located from the tables which are stored in the data repositories 414 and 415. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets and secure sockets, RPC, RMI, HTTP, Web Services (XML-RPC, JAX-RPC, SOAP, etc.). Other variations are possible. Also, other functionality could be provided by each component/module, or existing functionality could be distributed amongst the components/modules in different ways, yet still achieve the functions of an tracker.

Furthermore, in some embodiments, some or all of the components of the tracker 410 may be implemented or provided in other manners, such as at least partially in firmware and/or hardware, including, but not limited to one ore more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored (e.g., as software instructions or structured data) on a computer-readable medium, such as a hard disk, a memory, a network, or a portable media article to be read by an appropriate drive or via an appropriate connection. The system components and data structures may also be transmitted via generated data signals (e.g., as part of a carrier wave or other analog or digital propagated signal) on a variety of computer-readable transmission mediums, such as media 405, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

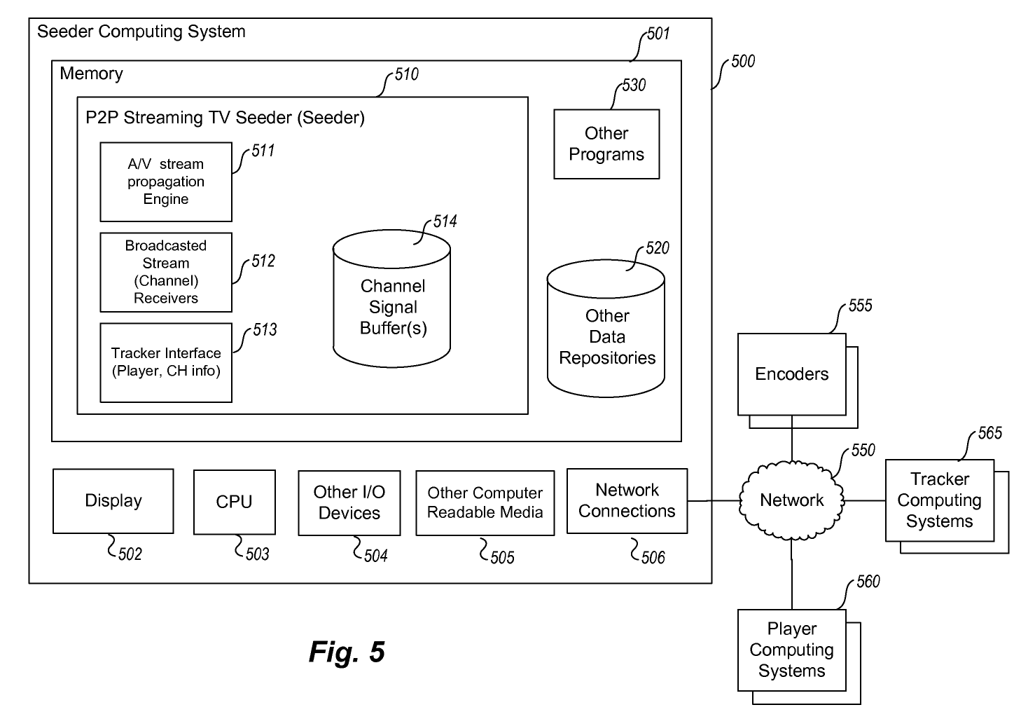

FIG. 5 is an example block diagram of an example computing system for practicing embodiments of a seeder computing system for propagating content in a PSITS to one or more players. In a typical embodiment, the P2P Internet TV Seeder (seeder) 510 includes one or more A/V stream propagation engines 511, one or more broadcasted stream (channel) receivers 512, one or more tracker interfaces 513, and more or more channel signal buffers 514 for storing signal blocks for propagation to one or more players. Other and/or different modules may be implemented. In addition, the seeder 510 may interact via a network 550 with encoders or broadcaster systems 550, one or more player computing systems 560, and/or one or more tracker computing systems 565 as described above over the network 550 using secure data communications such as TCP/IP with SSL. The tracker computing system 565 may, for example, execute a tracker as illustrated with reference to FIG. 4.

As discussed with reference to the tracker of FIG. 4, the seeder 510 may similarly be implemented in various ways and/or using various known or proprietary techniques. In particular, the seeder 510 may be implemented in hardware, software, and/or firmware. Software portions of the seeder 510 may be implemented using one or more programming languages and associated tools (e.g., compilers, interpreters, linkers, etc.) to generate code portions (e.g., instruction sequences) that may be processed by hardware components (e.g., a CPU) and/or software components (e.g., a virtual machine). Code implementing the seeder 510 may similarly be distributed via various computer program products similar to the tracker of FIG. 4. In addition, the seeder 510 may be decomposed, if at all, using various techniques, including client-server architectures, N-tier architectures, Web Services (e.g., SOAP), classes, libraries, archives, etc.

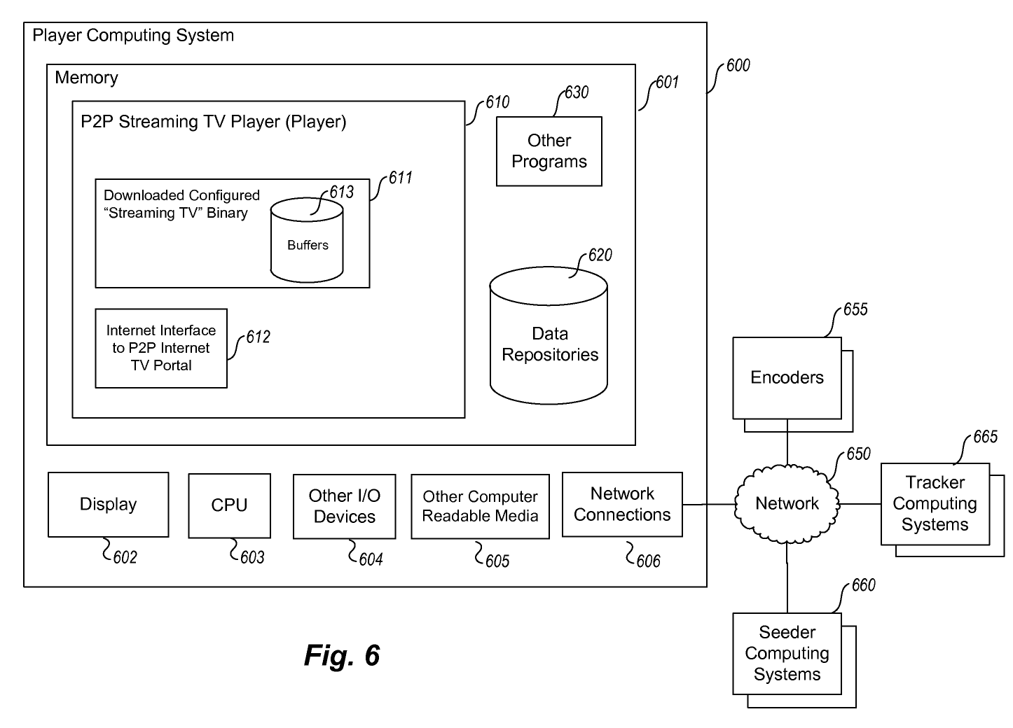

FIG. 6 is an example block diagram of an example computing system for practicing embodiments of a player computing system for receiving, displaying, and propagating live streamed broadcast content according to embodiments of a PSITS. In a typical embodiment, the P2P Internet TV Player (player) 610 includes a downloaded configured “streaming TV” binary 611, which includes one or more buffers 613 for holding channel signal blocks, and an interface to the P2P Internet TV Portal (PSITS portal) 612. Other and/or different modules may be implemented. In addition, the player 610 may interact via a network 650 with encoders or broadcaster systems 655, one or more tracker computing systems 665, and/or one or more seeder computing systems 660 as described above over the network 650 using secure data communications such as TCP/IP with SSL. The tracker computing system 665 may, for example, execute a tracker as described above with reference to FIG. 4. The seeder computing system 660 may, for example, execute a seeder as illustrated with reference to FIG. 5.

As discussed with reference to the tracker of FIG. 4, the player 610 may similarly be implemented in various ways and/or using various known or proprietary techniques. In particular, the player 610 may be implemented in hardware, software, and/or firmware. Software portions (source code) of the player 610 may be implemented using one or more programming languages and associated tools (e.g., compilers, interpreters, linkers, etc.) to generate code portions (e.g., instruction sequences) that may be processed by hardware components (e.g., a CPU) and/or software components (e.g., a virtual machine). Code implementing the player may similarly be distributed via various computer program products similar to the tracker of FIG. 4.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/049,333, entitled “SCALABLE PEER-TO-PEER STREAMING INTERNET TELEVISION,” filed Apr. 30, 2008, is incorporated herein by reference, in its entirety. From the foregoing it will be appreciated that, although specific embodiments have been described herein for purposes of illustration, various modifications may be made without deviating from the spirit and scope of the invention. For example, the methods and systems for performing the dissemination and propagation of broadcasted signals using peer-to-peer techniques discussed herein are applicable to other architectures. Also, the methods, techniques, and systems discussed herein are applicable to differing protocols, encryption schemes, communication media (optical, wireless, cable, etc.) and devices (such as wireless handsets, electronic organizers, personal digital assistants, portable email machines, game machines, pagers, navigation devices such as GPS receivers, etc.).

1. A method in a computing environment for secured delivery of streamed audio and/or video content to one or more network-ready devices, comprising:
sending electronic instructions to direct the transmission of data from an encoded encrypted audio and/or video signal that contains the streamed audio and/or video content from one or more encoders to one or more seeder computing systems that store the transmitted data; and
sending electronic instructions to direct one of the one or more network-ready devices to electronically receive from one of the one or more seeder computing systems a buffer of an initial portion of stored transmitted data of the encoded encrypted signal containing a portion of the streamed audio and/or video content and to electronically receive subsequent portions of the stored transmitted data from one or more peer network-ready devices or from the one of the one or more seeder computing systems.

2. The method of claim 1 wherein the sending of the electronic instructions is performed by at least one of one or more tracker computing systems.

3. The method of claim 1 wherein the audio and/or video signal contains live broadcast television channel content.

4. The method of claim 1 wherein the audio and/or video signal contains archived audio and/or video content.

5. The method of claim 1 wherein the initial portion of the encoded encrypted signal is an 100 second segment of the signal.

6. The method of claim 1 wherein it is determined whether to direct the one of the one or more network-ready devices to receive subsequent portions of the signal from the one or more peer network-ready devices or from the one of the one or more seeder computing systems based upon testing performance parameters related to sending or receiving the initial portion of the encoded encrypted signal by the one of the one or more network-ready devices.

7. The method of claim 1, further comprising:
electronically receiving tracking information from the one of the one or more network-ready devices.

8. The method of claim 1 wherein the tracking information tracks information relating to what has been viewed on the one of the one or more network-ready devices.

9. The method of claim 1, further comprising electronically providing encoding and/or encryption parameters to the one or more encoders.

10. The method of claim 1, further comprising electronically providing one or more decryption keys to the one of the one or more network-ready devices to enable the one of the one or more network-ready devices to decrypt received portions of the stored transmitted data that contains the encoded encrypted signal.

11. A computer-readable memory medium containing computer instructions that are configured to, when executed, to control a computer system to securely deliver streamed audio and/or video content to one or more network-ready players by performing a method comprising:
sending instructions to direct the transmission of data from an encoded encrypted audio and/or video signal comprising the streamed audio and/or video content from one or more encoders to one or more seeders that store the transmitted data; and
sending instructions to direct one of the one or more network-ready players to receive from one of the one or more seeders a buffer of an initial portion of the stored transmitted data that contains a portion of the encoded encrypted audio and/or video signal and to receive subsequent portions of the stored transmitted data from one or more peer network-ready players or from the one of the one or more seeders.

12. A tracking computing system comprising:
a memory;
encoder logic, stored in the memory, and configured when executed on a computer processor to communicate with one or more encoders to direct transmission of an encoded encrypted audio and/or video signal from the one or more encoders to be stored as encoded encrypted data on one or more seeder computing systems; and
player device logic, stored in the memory, and configured when executed on a computer processor to communicate with one or more player devices to receive from one of the one or more seeder computing systems a buffer of an initial portion of the stored encoded encrypted data and to receive subsequent portions of the stored data from one or more peer player devices or from the one of the one or more seeder computing systems.

13. A computer-readable memory medium containing instructions configured, when executed, to control a computing system propagate a broadcast signal containing secure streamed audio and/or video content by performing a method comprising:
receiving in near real-time signal data from encoded encrypted audio and/or video broadcast signal data from one or more encoders;
storing the received near real-time signal data in encoded encrypted form in a computing memory;
receiving electronic instructions from a second computing system regarding distribution of portions of the received near real-time signal data; and
distributing in encoded encrypted form portions of the stored data in near real-time to one or more player computing systems in accordance with the received electronic instructions.

14. The computer-readable memory medium of claim 13 wherein the stored signal data is distributed to a player computing system that executes a binary application for receiving the distributed data in encoded encrypted form and that only decrypts portions of the distributed data when presenting the data.

15. The computer-readable memory medium of claim 13, the method further comprising;
testing the performance of the one or more player computing systems in conjunction with distributing the portions of the stored data.

16. The computer-readable memory medium of claim 13 wherein the broadcast signal data is a television signal.

17. The method of claim 13 wherein the broadcast signal data is archived audio and/or visual data made available from a broadcasting application.

18. A seeder computing system comprising:
a memory;
broadcast stream receiver logic, stored in the memory and configured, when executed on a computer processor, to receive from one or more encoders near real-time signal data from one or more encoded encrypted audio and/or video broadcast signals and to store the received near real-time signal data in encoded encrypted form in a computing memory; and
tracker interface logic, stored in the memory and configured, when executed on a computer processor, to communicate with one or more tracker devices to receive electronic instructions regarding distribution of portions of the received near real-time signal data; and
propagation logic, stored in the memory, and configured when executed on a computer processor to distribute in encoded encrypted form portions of the stored data in near real-time to one or more player computing systems in accordance with the received electronic instructions.

19. A computing environment, comprising:
an encoder that is configured to receive broadcast signal from one or more television channels or from archived audio and/or visual content, to encode and encrypt the signal according to a received set of parameters, and to forward the encoded and encrypted signal;
a seeder computing system that is configured to receive the encoded and encrypted signal from the encoder and to store the signal as encoded encrypted data; and
a tracker computing system that is configured to send a set of encoding and encrypting parameters to the encoder, to send an indication of a designated seeder computing system to a network-ready player device to enable the player device to receive a first portion of audio and/or video content from the stored encoded encrypted data from the designated seeder and to receive a subsequent portion of the stored encoded encrypted data from the designated seeder and/or a network-ready peer player device.

20. The computing environment of claim 19 wherein the broadcast signal is a television or radio signal.

21. The computing environment of claim 19 wherein the broadcast signal contains archived audio and/or video content.

22. The computing environment of claim 19 wherein the tracker computing system is configured to send an indication of a designated seeder computing system to a binary application of the network-ready player device.

23. The computing environment of claim 19 wherein the stored encoded encrypted data and/or the tracking system is configured to cause the network-ready player device to display advertisements interspersed in a received portion of audio and/or video content from the stored encoded and encrypted data received from the designated seeder.

24. The computing environment of claim 23 wherein the advertisements are advertisements specific to the network-ready player device.

25. The computing environment of claim 19 wherein the stored encoded encrypted data and/or the tracking system is configured to cause the network-ready player device to display one or more overlays interspersed in a received portion of audio and/or video content from the stored encoded encrypted data.

26. The computing environment of claim 25 wherein the overlays are transaction overlays are used to perform an interactive transaction.

27. The computing environment of claim 25 wherein the transaction overlays are used to perform a purchase of a good or service or to provide a voting mechanism.
